(19) United States
(12) Patent Application Publication
(10) Pub. No.: US 2021/0009235 A1
(43) Pub. Date: Jan. 14, 2021

(54) SNOW VEHICLE

(71) Applicant: YAMAHA HATSUDOKI KABUSHIKI KAISHA, Iwata (JP)

(72) Inventors: Hiroyuki OKADA, Minocqua, WI (US); Lucas Matthew FUREY, Woodruff, WI (US); Gerard John KARPIK, Eveleth, MN (US); James Christopher VIZANKO, Arbor Vitae, WI (US)

(21) Appl. No.: 16/508,506

(22) Filed: Jul. 11, 2019

(51) Int. Cl. B62M 27/02

(52) U.S. Cl. CPC B62M 27/02; B62M 2027/028; B62M 2027/025

(57) ABSTRACT

A snow vehicle basically includes a vehicle body, a saddle seat, at least one ski, an engine, a starter motor and a lithium power module. The engine is attached to the vehicle body. The starter motor is operatively coupled to the engine and electrically coupled to a first electrical connection. The lithium power module has a lithium battery with a second electrical connection that is configured to be toollessly connected and disconnected to the first electrical connection.

### BACKGROUND

### Technical Field

The present invention generally relates to snow vehicles. More specially, the present invention relates to a snow vehicle that has a battery and travels over snow or ice covered ground in cold weather.

### Background Information

Generally, snow vehicles such as snowmobiles and snow bikes are land vehicles that are used for transportation, recreation, or utility in cold and snowy conditions. Typically, a snow vehicle includes a vehicle body supported by a track belt unit with an endless track belt and at least one steerable skis positioned in a forward direction of the track belt unit. The vehicle body has a saddle seat, an engine that drives the endless track belt, and a handlebar that is coupled to the skis. A rider can turn the handlebar to steer the skis to the left and right.

Traditionally, snowmobiles used two-stroke engines to generate power to turn the endless track belt. Two-stroke engines generally provide relatively high power-to-weight and power-to-size ratios. However, two-stroke engines have higher exhaust emissions than four-stroke engines, and require the rider to use a mixture of gasoline and oil as fuel. Also, in view of environmental concerns, there has been a trend to decrease exhaust emissions from internal combustion engines.

Accordingly, some of the snowmobile manufacturers have developed snowmobiles that used a four-stroke engine. Often, a four-stroke engine for a snowmobile uses an electric starter motor to start the engine, which is typically not used for starting a two-stroke engine in a snowmobile. Thus, a snowmobile with a four-stroke engine typically needs a battery for the electric starter motor. One example of a snowmobile having a battery for supplying electrical power to an electric starter motor is disclosed in U.S. Patent Application Publication No. 2019/0136818.

### SUMMARY

Generally, the present disclosure is directed to various features of a snow vehicle provided with a portable power module that can used to supply electrical power to an electric starter.

In view of the state of the known technology and in accordance with one aspect of the present disclosure, a snow vehicle is provided that basically comprises a vehicle body, a saddle seat, at least one skis, an engine, a starter motor and a lithium power module. The saddle seat is provided on the vehicle body. The at least one skis is steerably arranged with respect to the vehicle body. The engine is attached to the vehicle body. The starter motor is operatively coupled to the engine and electrically coupled to a first electrical connection. The lithium power module has a lithium battery with a second electrical connection that is configured to be toollessly connected and disconnected to the first electrical connection.

With the snow vehicle according to this aspect, it is possible to easily install and remove the lithium power module without using tools.

In accordance with another aspect of the present disclosure, a snow vehicle is provided that basically comprises a vehicle body, a saddle seat, at least one skis, an engine and a lithium power module. The saddle seat is provided on the vehicle body. The at least one skis is steerably arranged with respect to the vehicle body. The vehicle body has a longitudinal center plane dividing the snow vehicle into first and second lateral sides. The engine is attached to the vehicle body and has an exhaust system that is primarily disposed on one of the first and second lateral sides. The lithium power module has a lithium battery, and is disposed on the other of the first and second lateral sides adjacent to the engine.

With the snow vehicle according to this aspect, it is possible keep the lithium battery while avoiding excess heating of the lithium battery from the exhaust system.

In accordance with another aspect of the present disclosure, a snow vehicle is provided that basically comprises a vehicle body, a windshield, a saddle seat, at least one skis and a lithium power module. The windshield is provided on the vehicle body. The saddle seat is provided on the vehicle body. The at least one skis is steerably arranged with respect to the vehicle body. The lithium power module has a lithium battery, and is disposed in an area defined between the windshield and the saddle seat.

With the snow vehicle according to this aspect, it is possible to easily install and remove the lithium power module while in the seated position.

In accordance with another aspect of the present disclosure, a snow vehicle is provided that basically comprises a vehicle body, a saddle seat, at least one skis and a lithium power module. The vehicle body has a saddle seat section. The saddle seat is provided on the saddle seat section of the vehicle body. The at least one skis is steerably arranged with respect to the vehicle body. The lithium power module has a lithium battery, and is disposed in one of the saddle seat section of the vehicle body and the saddle seat.

With the snow vehicle according to this aspect, it is possible to position the lithium power module in a protected and secure location.

In accordance with another aspect of the present disclosure, a snow vehicle is provided that basically comprises a vehicle body, a saddle seat, at least one skis, a drive unit, an engine, a starter motor, a battery and at least one user operated switch. The vehicle body has a saddle seat section. The saddle seat is provided on the saddle seat section of the vehicle body. The at least one skis is steerably arranged with respect to the vehicle body. The drive unit is supported by the saddle seat section of the vehicle body. The drive unit includes a track belt. The engine is attached to the vehicle body and is operatively coupled to the drive unit to drive the drive unit in a forward direction. The starter motor is operatively coupled to the engine and operatively coupled to the drive unit. The battery is electrically coupled to the starter motor. The user operated switch operates the starter motor to start the engine in a first vehicle condition, and operates the starter motor to drive the drive unit in a reverse direction in a second vehicle condition.

Also, other objects, features, aspects and advantages of the disclosed snow vehicle will become apparent to those skilled in the snow vehicle field from the following detailed description, which, taken in conjunction with the annexed drawings, discloses preferred embodiments of the snow vehicle.

### BRIEF DESCRIPTION OF THE DRAWINGS

Referring now to the attached drawings which form a part of this original disclosure.

FIG. 1 is a side elevational view of a snowmobile (a snow vehicle) in accordance with the illustrative embodiments.

FIG. 2 is a perspective view of a portion of the snowmobile illustrated in FIG. 1 having a battery receiving port or socket located in a dash panel area between a windshield and a steering column of the snowmobile.

FIG. 3 is a perspective view, similar to FIG. 2, of a portion of the snowmobile illustrated in FIG. 1 but having a portable power source (a lithium power module) inserted into the battery receiving port.

FIG. 4 is an oblique view of the dash panel area of the snowmobile illustrated in FIG. 1 with the portable power source removed from the battery receiving port.

FIG. 5 is an oblique view, similar to FIG. 4, of the dash panel area of the snowmobile illustrated in FIG. 1 with a port cover pivoted to an open position to expose the first electrical terminals of the battery receiving port.

FIG. 6 is a first end perspective view of the portable power source that is configured to be plugged into the battery receiving port.

FIG. 7 is a second end perspective view of the portable power source showing the second electrical terminals that are configured to be toollessly connected and disconnected to the first electrical terminals of the battery receiving port.

FIG. 8 is a functional block diagram of the electrical system of the snowmobile illustrated in FIG. 1 receiving power from the portable power source (the lithium power module) illustrated in FIGS. 6 and 7.

FIG. 9 is a functional block diagram of the electronic controller of the portable power source (the lithium power module) illustrated in FIGS. 6 and 7.

FIG. 10 is a flowchart depicting operational steps of a program executed by the electronic controller of the portable power source (the lithium power module) that functions to ensure a sufficient battery reserve for using the portable power source to start the engine of the snowmobile a predetermined number of times;

FIG. 11 is a perspective view of a saddle seat section of a vehicle body of the snowmobile illustrated in FIG. 1 having a battery receiving port or socket located in one of the saddle seat section of the vehicle body and the saddle seat.

FIG. 12 is a perspective view, similar to FIG. 12, of the saddle seat section of the vehicle body of the snowmobile but having a portable power source (a lithium power module) inserted into the battery receiving port.

FIG. 13 is a top plan view of a front section of a vehicle body of the snowmobile illustrated in FIG. 1 having a battery receiving port or socket located in the engine compartment.

FIG. 14 is a top plan view, similar to FIG. 13, of the front section of a vehicle body of the snowmobile but having a portable power source (a lithium power module) inserted into the battery receiving port.

FIG. 15 is a top plan view of a front section of a vehicle body of the snowmobile illustrated in FIG. 1 having a battery receiving port located in the engine compartment and thermostatically controlled air dampers.

FIG. 16 is a side elevational view of a front portion of the snowmobile illustrated in FIG. 15 having the thermostatically controlled air dampers in a retracted position to permit air to flow towards the lithium battery.

FIG. 17 is a side elevational view of a front portion of the snowmobile illustrated in FIGS. 15 and 16 having the thermostatically controlled air dampers in an extended position to block air from flowing towards the lithium battery.

FIG. 18 is a functional block diagram of the snowmobile of the illustrated embodiments for reversing the drive unit of the snowmobile using the starter motor.

FIG. 19 is an alternate functional block diagram of the snowmobile of the illustrated embodiments for reversing the drive unit of the snowmobile using the starter motor.

FIG. 20 is a simplified circuit diagram of the control circuit of FIG. 19 used for suppling current to the starter motor in an engine starting state (i.e., a first polarity for starting the engine).

FIG. 21 is a simplified circuit diagram of the control circuit of FIG. 19 used for suppling current to the starter motor in a reverse drive state (i.e., a second polarity for driving the drive unit in reverse).

FIG. 22 is a perspective view of modified dash panel area of the snowmobile illustrated in FIG. 1 having a first electrical connection with a pluggable power and signal outlet in a dash panel area between a windshield and a steering column of the snowmobile for receiving a second electrical connection formed on one end of an electrical cord that has its other end connected to a modified portable power source (a lithium power module).

FIG. 23 is a perspective view of the front portion of the snowmobile illustrated in FIG. 22 in which the modified portable power source is connected to the first electrical connection of the snowmobile via the second electrical connection of the electrical cord.

FIG. 24 is an oblique view of a modified dash panel area for the snowmobile illustrated in FIG. 1 having a first electrical connection with a power and signal socket in a dash panel area between a windshield and a steering column of the snowmobile for receiving a modified portable power source (a lithium power module).

FIG. 25 is an enlarged oblique view of the modified dash panel area and the modified portable power source illustrated in FIG. 24.

FIG. 26 is an enlarged oblique view, similar to FIG. 25, of the modified dash panel area but with the modified portable power source removed.

FIG. 27 is a first side perspective view of the modified portable power source that is configured to be plugged into the power and signal socket of the modified dash panel shown in FIGS. 24 to 26.

FIG. 28 is a second side perspective view of the modified portable power source that is configured to be plugged into the power and signal socket of the modified dash panel shown in FIGS. 24 to 26.

It should be noted that these figures are intended to illustrate the general characteristics of methods, structure and/or materials utilized in certain illustrative embodiment and to supplement the written description provided below. These figures are to reduce scale of the actual snowmobile but may not precisely reflect the precise structural or performance characteristics of any given embodiment. However, the dimensional relationships and the arrangement of the parts of the snowmobile are accurately depicted, except for the functional block diagrams.

### DETAILED DESCRIPTION OF EMBODIMENTS

Selected embodiments will now be explained with reference to the drawings. It will be apparent to those skilled in the snowmobile field from this disclosure that the following descriptions of the embodiments are provided for illustration only and not for the purpose of limiting the invention as defined by the appended claims and their equivalents. Like reference numerals in the drawings denote like similar or identical elements or features, and thus the descriptions of the similar or identical elements or features may be omitted in later embodiments.

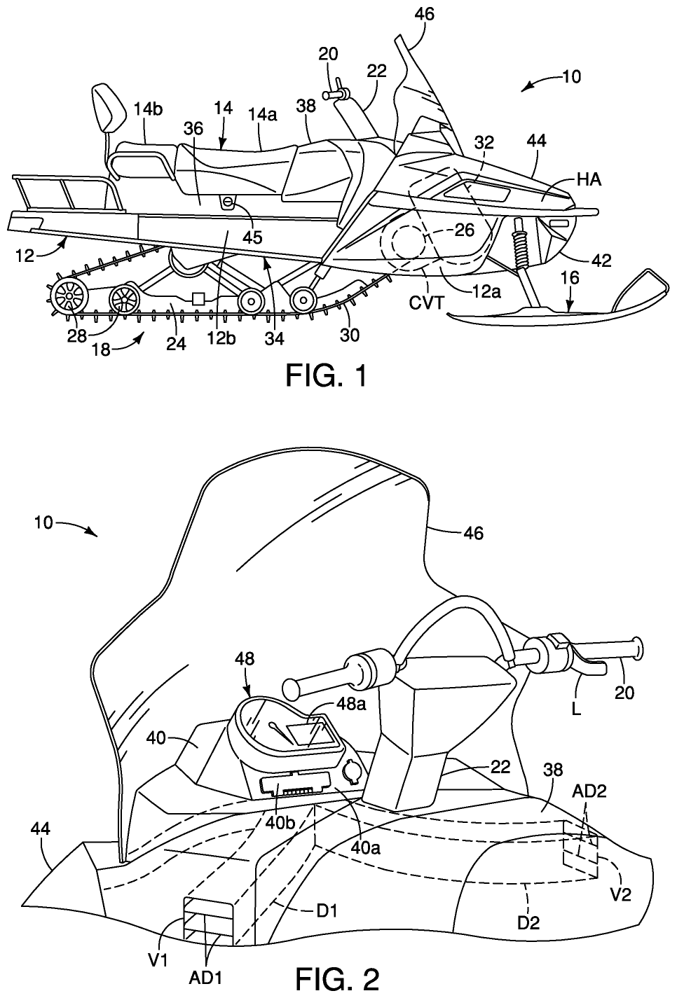

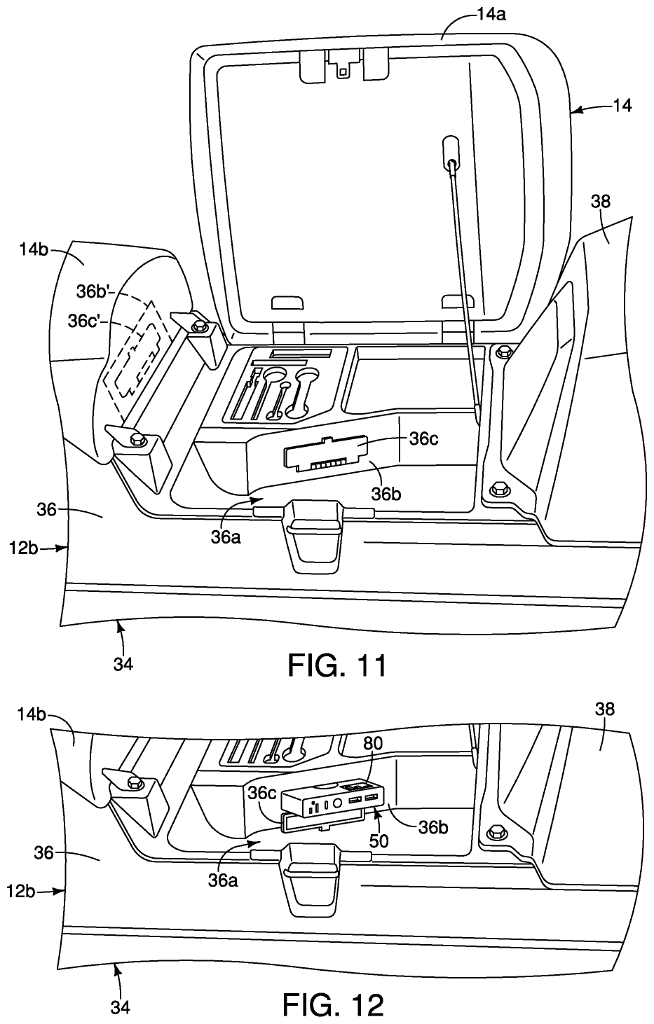

Referring initially to FIGS. 1 to 5, a snowmobile 10 is illustrated that is configured in accordance with the illustrative embodiments. The snowmobile 10 is a saddle-riding type vehicle that basically includes a vehicle body 12, a saddle seat 14, a pair of skis 16 and a drive unit 18. The skis 16 are supported by a front section 12a of the vehicle body 12, which can also be referred to as a snowmobile body. The skis 16 are turnable in conventional manner by a handlebar 20 that is attached to an upper end of a steering column 22. The vehicle body 12 has a saddle seat section 12b. The saddle seat 14 is provided on the saddle seat section 12b of the vehicle body 12. The saddle seat 14 includes a movable seat 14a and a stationary seat 14b as seen in FIG. 11. It will be apparent from this disclosure that the present invention can also be used in snow bikes.

The drive unit 18 is supported by the saddle seat section 12b of the vehicle body 12. The drive unit 18 includes at least one beam 24 (only one shown), at least one driving wheel 26 (only one shown), a plurality of driven wheels 28 and a track belt 30. The track belt 30 is wound around the driving wheels 26 and the driven wheels 28. The driving wheels 26 are rotated by driving power supplied from an internal combustion engine 32 via a continuously variable transmission CVT in conventional manner. The driven wheels 28 are driven with a circulatory rotation of the track belt 30.

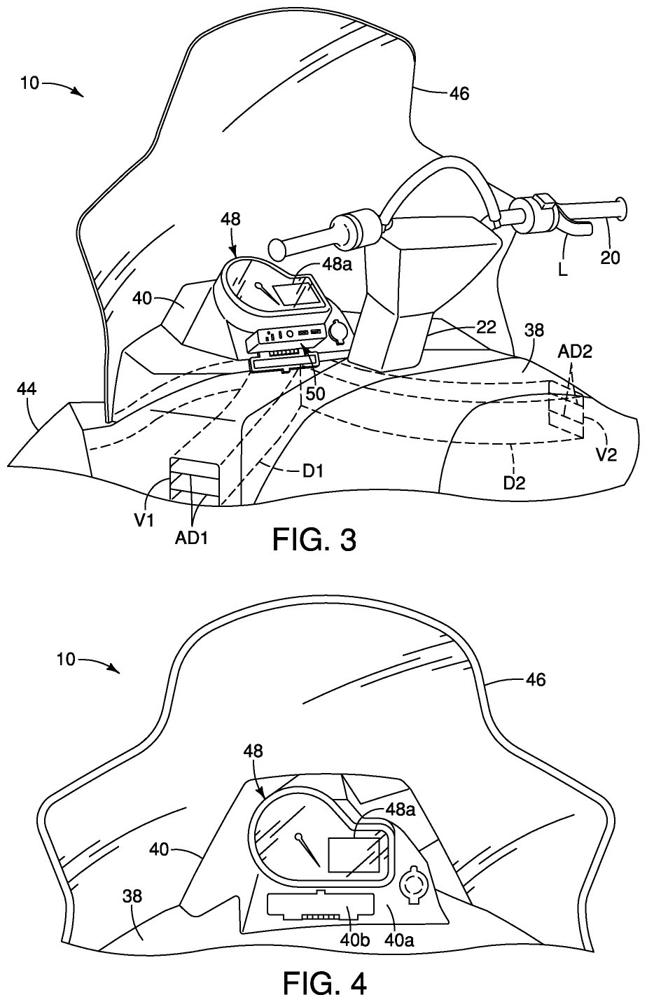

The vehicle body 12 includes a frame 34 and various body panels such has a seat panel 36, a center console panel 38, a dash panel 40, a hull 42 and a front engine cover 44. The frame 34 is typically made of a metal, while the body panels are typically made of a non-metallic material such as reinforced plastic. The saddle seat 14 is mounted on the seat panel 36. Here, the seat panel 36 includes a storage area or compartment 36a as seen in FIG. 11. The movable seat 14a is hinged to the seat panel 36 between a closed position overlying the storage area 36a to conceal the storage area 36a and an open position exposing the storage area 36a to provide access to the storage area 36a. The movable seat 14a preferably has a lock 45 as seen in FIG. 1. The hull 42 and the front engine cover 44 define an engine compartment for receiving the engine 32. As seen in FIGS. 2 and 3, two ducts D1 and D2 are provided for directing heated air from the engine compartment that is defined by the hull 42 and the front engine cover 44 to vent outlets V1 and V2.

The engine 32 is a four-stroke engine that is attached to the vehicle body 12. More specifically, the engine 32 is supported by the frame 34 and covered by the front engine cover 44. A user input L (e.g., the throttle lever) is provided on the handlebar 20 for regulating the throttle of the engine 32. Here, the snowmobile 10 further comprises a windshield 46 that is attached to the vehicle body 12. The windshield 46 is located in an area between the dash panel 40 and the front engine cover 44. Since snowmobiles are well known, the construction of the vehicle body 12 can be any conventional or unconventional snowmobile body. Thus, the vehicle body 12 will not be discussed in further detail herein.

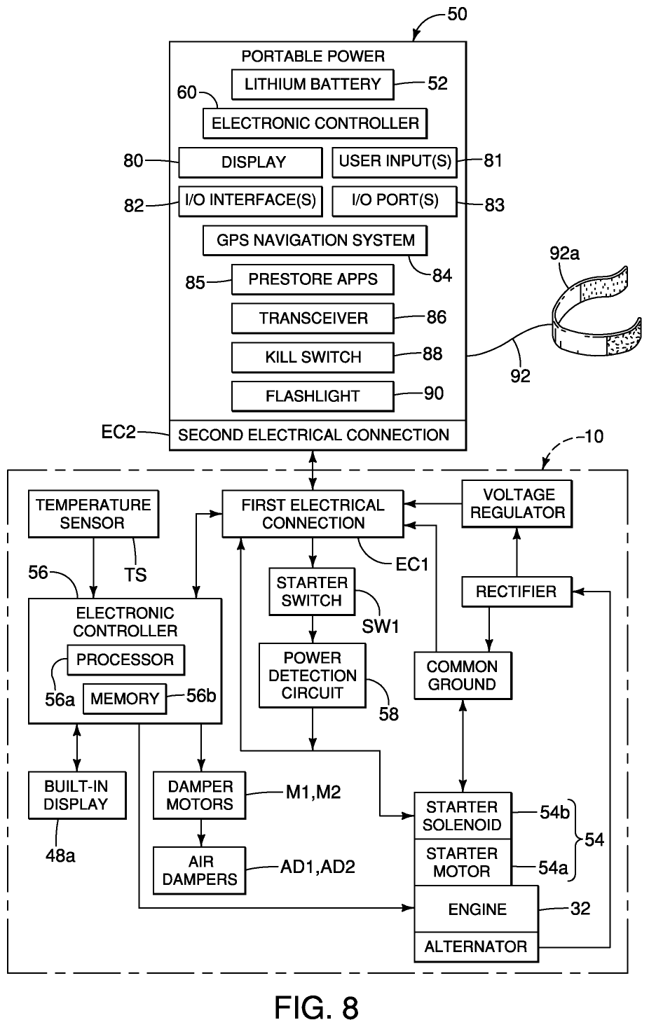

As seen in FIGS. 2 to 5, the snowmobile 10 further comprises an instrument cluster 48 provided in the dash panel 40. The instrument cluster 48 includes a built-in display 48a (hereinafter the “display 48a”) among other things. The display 48a can be any conventional display such as an LCD display. The display 48a notifies the rider of various operating conditions of the snowmobile 10 or other information. Here, in the first embodiment, the dash panel 40 also includes a battery support 40a that is located below the instrument cluster 48. A lid 40b is pivotally attached to the battery support 40a to cover a first electrical connection EC1, which is electrically connected to an electrical system of the snowmobile 10 as shown in FIG. 8. Here, the battery support 40a defines a battery receiving port or socket formed in the dash panel 40. However, the battery support 40a is not limited to this configuration.

Referring now to FIGS. 3 and 6 to 8, the snowmobile 10 further comprises a portable lithium power module 50, which preferably includes a lithium battery 52 (FIG. 8). The lithium battery 52 can be any suitable lithium-ion battery (e.g., Li-ion battery with lithium cobalt dioxide (LiCoO₂), lithium manganese oxide (LiMn₂O₄), or lithium iron phosphate (LiFePO₄) as a cathode material. Preferably, the lithium battery 52 is a lithium-iron battery (e.g., Li—Fe battery with lithium iron phosphate (LiFePO₄) as a cathode material). The lithium battery 52 is a rechargeable battery. For example, the lithium battery 52 has at least a 600 peak Amp with a capacity of approximately 29.6 watt hours so as to provide approximately seventy-eight (78) engine starts on a single charge. More preferably, the lithium battery 52 has at least an 800 peak Amp with a capacity of approximately 37 watt hours, and even more preferably, the lithium battery 52 has at least a 1000 peak Amp with a capacity of approximately 144 watt hours. Of course, it will be apparent to from this disclosure that the lithium battery 52 is not limited to the above-mentioned amperages and watt hour capacities.

Here, the portable lithium power module 50 has several functions and/or features in addition to supplying electrical power to an electrical system (12 to 48 Volt DC-BUS) of the snowmobile 10. However, in its simplest form, the portable lithium power module 50 can be merely a pluggable battery without any addition functions and/or features. In any case, the portable lithium power module 50 is configured to be electrically connected and electrically disconnected from the electrical system (12 to 48 Volt DC-BUS) of the snowmobile 10 without using any tools. The portable lithium power module 50 is provided with a second electrical connection EC2 that is electrically connected to the lithium battery 52. The second electrical connection EC2 is configured to electrically mate with the first electrical connection EC1 of the electrical system of the snowmobile 10. Thus, the lithium power module 50 is removably supported to the battery support 40a while the first and second connections E1 and E2 are electrically connected. Here, the first electrical connection EC) includes a pair of male electrical contacts MC1 and MC2, while the second electrical connection EC2 includes a pair of female electrical contacts FC1 and FC2. However, the first and second electrical connections EC1 and EC2 can be any suitable electrical connections for transferring electrical power from the lithium battery 52 to the electrical system of the snowmobile 10. In the illustrated embodiment, the portable lithium power module 50 can communicate data with the components of the snowmobile 10 using Power Line Communication (PLC), which is a communication technology that enables sending data over existing power cables. Alternatively, one or more dedicated data connections can be used for communicating data between the portable lithium power module 50 and the components of the snowmobile 10.

A primary function of the portable lithium power module 50 is to provide electrical power to an electric starter 54 (FIG. 8). In the illustrated embodiment, for example, the electric starter 54 includes a starter motor 54a and a starter solenoid 54b. The starter motor 54a of the electric starter 54 is electrically coupled to a first electrical connection E1 via the starter solenoid 54b. Here, since the electrical system is preferably a 12 to 48 Volt electrical system, the starter motor 54a is a 12 to 48 Volt starter motor, and the starter solenoid 54b is a 12 to 48 Volt starter solenoid. The starter solenoid 54b is electrically connected to the lithium battery 52 of the portable lithium power module 50 when the portable lithium power module 50 is plugged into the snowmobile. Namely, the lithium power module 50 has the second electrical connection EC2 that is configured to be toollessly connected and disconnected to the first electrical connection EC1 that is electrically connected to the starter solenoid 54b of the snowmobile 10. The engine 32 is started by depressing an ignition switch SW1 (e.g., a button, a lever or other suitable user operated input device) which is shown in FIG. 8.

The starter motor 54a is used to start the engine 32 using the electrical power from the lithium battery 52 in a conventional manner. The starter motor 54a can also be used to drive the drive unit 18 in reverse as explained below.

A secondary function of the portable lithium power module 50 is to display information (e.g., battery voltage, battery level, battery current, etc.) of the lithium battery 52 to a rider using the display 48a of the snowmobile 10. Also, depending on the configuration (e.g., stored applications, features, etc.) of the portable lithium power module 50, the portable lithium power module 50 can display other information (e.g., map (trail) data, GPS data, navigation, emergency alerts, maintenance logging data, weather, text messages, vehicle status, suspension settings, etc.) as needed and/or desired on the display 48a of the snowmobile 10. Moreover, the battery support 40a can include an electric battery heater (not shown) for heating the battery support 40a, which in turn will heat the lithium battery 52. In such a case, the electric battery heater receives electrical power from the lithium battery 52 based on the internal temperature. Alternatively, the lithium battery 52 can include an electric battery heater (not shown) for heating the lithium battery 52.

In the embodiment shown in FIGS. 2 to 5, the lithium power module 50 is disposed in an area defined between the windshield 46 and the saddle seat 14. More particularly, as seen in FIGS. 2 to 5, the lithium power module 50 is disposed in the battery support 40a formed in the dash panel 40 between the windshield 46 and the steering column 22. In this way, the lithium power module 50 is can be easily installed and removed by the rider. Also, as seen in FIG. 3, in this embodiment, the lithium power module 50 is partially exteriorly disposed and partially interiorly disposed while the first and second electrical connections EC1 and EC2 are connected.

As previously mentioned, the lithium power module 50 is toollessly connected to the battery support 40a for electrically connecting the lithium battery 52 to the electrical system of the snowmobile 10. Here, the lithium power module 50 is merely pushed into the battery receiving port defined by the battery support 40a with the lithium power module 50 being frictionally retained. However, the battery support 40a can be provided with one or more hand operated latches for more securely retaining the lithium power module 50 in the battery receiving port defined by the battery support 40a. Alternatively, a push type latching system such as used for computer memory cards could be used. In any case, the lithium power module 50 is preferably a quick-connect configuration in which the lithium battery 52 is electrically connected to the electrical system of the snowmobile 10 without using a tool and the lithium battery 52 is electrically disconnected from the electrical system of the snowmobile 10 without using a tool in a repeatable manner.

Here, as seen in FIG. 8, the snowmobile 10 further comprises an electronic controller 56 that is an engine control unit (ECU) for controlling the operation of the engine 32. The term “electronic controller” as used herein refers to hardware that executes a software program, and does not include a human. The electronic controller 56 is preferably a microcomputer that includes one or more processors and one or more computer storage devices (i.e., computer memory). For example, the electronic controller 56 includes a processor 56a and memory 56b. The electronic controller 56 is formed of one or more semiconductor chips that are mounted on one or more circuit boards. Also, the electronic controller 56 may be separate of the engine control unit (ECU). Although illustrated as separate elements, those of skill in the art will recognize that the processor 56a and the memory 56b can be mounted on a single circuit boards. The processor 56a can be a conventional central processing unit (CPU) or any other type of device, or multiple devices, capable of manipulating or processing information such as program code stored in the memory 56b in order to allow the electronic controller 56 to perform the functionality described herein. Processors and memory are extremely well known in the computer field and often used in the snowmobile field, therefore no further description will be provided. Moreover, the control of an engine using an engine control unit is well known in the snowmobile field, therefore no further description will be provided with respect to the control of the engine 32 using the electronic controller 56.

In the illustrated embodiments, the snowmobile 10 further comprises a power detection circuit 58. The power detection circuit 58 is electrically connected to an electrical path between the lithium battery 52 and the starter solenoid 54b. The electronic controller 56 is operatively coupled to the power detection circuit 58 and the engine 32. The electronic controller 56 is programmed to shut off the engine 32 in response to the power detection circuit 58 detecting the lithium battery 52 is no longer connected to the electrical system of the snowmobile 10. The power detection circuit 58 acts as a kill switch in the situation in which the portable lithium power module 50 is connected to the snowmobile 10 using a power cord and the portable lithium power module 50 is carried on the rider. While the power detection circuit 58 is indicated as a separate part from the electronic controller 56, it will be apparent from this disclosure that the power detection circuit 58 can be integrated with the electronic controller 56.

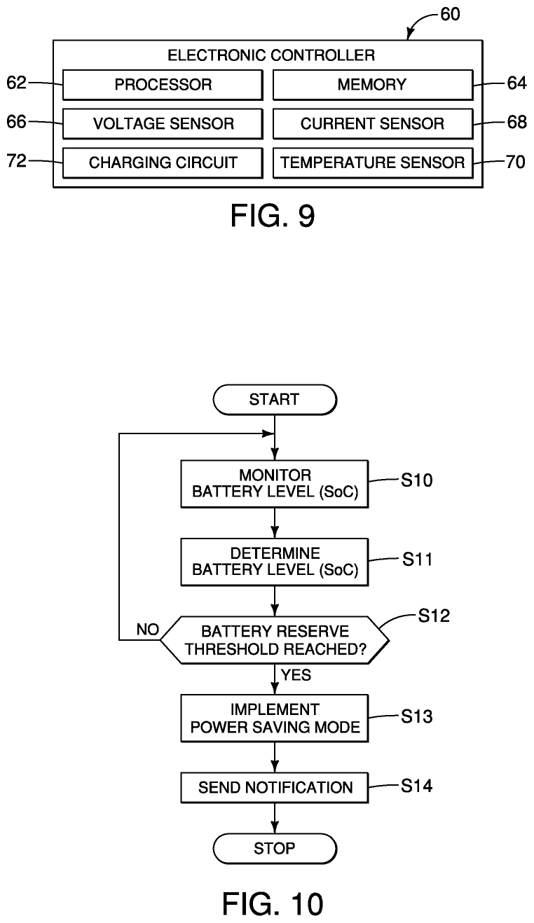

As seen in FIGS. 8 and 9, in the illustrated embodiments, the portable lithium power module 50 further includes an electronic controller 60. The electronic controller 60 is configured to communicate with the electronic controller 56 of the snowmobile 10. Here, the electronic controller 60 communicates with the electronic controller 56 using power-line communication. DC-BUS is one of several protocols for power-line communication. Alternatively, one or more data connections can be provided between the electronic controller 56 and the electronic controller 60 to allow for communication therebetwen. Likewise, the electronic controller 56 and the electronic controller 60 can communicate with other electrical components of the snowmobile 10 using one or more data connections.

The electronic controller 60 is preferably a microcomputer that includes one or more processors and one or more computer storage devices (i.e., computer memory devices). For example, the electronic controller 60 includes a processor 62 and memory 64 as illustrated in FIG. 9. The electronic controller 60 is formed of one or more semiconductor chips that are mounted on one or more circuit boards. Although illustrated as separate elements, those of skill in the art will recognize that the processor 62 and the memory 64 can be mounted on separate circuit boards. The processor 62 can be a conventional central processing unit (CPU) or any other type of device, or multiple devices, capable of manipulating or processing information such as program code stored in the memory 64 in order to allow the electronic controller 60 to perform the functionality described herein. Likewise, a timer module can be provided as a function of the processor, and can function to accurately measure the passage of time. Processors, memory and timers are extremely well known in the computer field and often used in the snowmobile field, therefore no further description will be provided.

Here, optionally, the electronic controller 60 further includes a voltage sensor 66, a current sensor 68, a temperature sensor 70 and a charging circuit 72. In this way, a variety of devices can be connected to the portable lithium power module 50 for receiving electrical power and/or for communicating with the electronic controller 60. The voltage sensor 66 is configured to detect the voltage of the lithium battery 52, while the current sensor 68 is configured to detect the current of the lithium battery 52. The voltage sensor 66 can be a voltage detection circuit that measures voltage between two points of the electrical circuit between the lithium battery 52 and the starter solenoid 54b. The voltage sensor 66 generates a voltage signal that is proportional to that voltage, and sends the voltage signal to the processor 62 which stores a voltage value in the memory 64. The current sensor 68 can be a current detection circuit that detects electric current in the electrical circuit between the lithium battery 52 and the starter solenoid 54b. The current sensor 68 generates a current signal that is proportional to that current, and sends the current signal to the processor 62 which stores a current value in the memory 64. The temperature sensor 70 is configured to detect the temperature of the lithium battery 52. The temperature sensor 70 generates a temperature signal that is indicative of the current temperature of the lithium battery 52. The temperature signal, the voltage signal and/or the current signal can be used by the processor 62 to calculate a battery level or state of charge (SoC) of the lithium battery 52 using conventional techniques. Charging circuits are extremely well known in the computer field, therefore no further description will be provided of the charging circuit 72. The charging circuit 72 is preferably configured to charge the lithium battery 52 using electrical power generated by the alternator and electrical power from an external source (e.g., a residential power supply).

As mentioned above, an electric battery heater (not shown) can be provided to heat the lithium battery 52 in very cold conditions when the engine 32 is not running. However, when the engine is running, air heated by the engine can be used to keep the lithium battery 52 warm. For example, the battery receiving port or socket of the battery support 40a is at least partially disposed in one or both of the ducts D1 and D2 so that the warm air from the engine compartment warms the lithium battery 52. Here, both of the ducts D1 and D2 are configured to direct air to the lithium battery 52. However, depending on the outside temperature where the snowmobile 10 is being used, the lithium battery 52 may become overheated if warm air from the engine compartment is continuously flow to the lithium battery 52. Thus, in one embodiment, to regulate the airflow to the lithium battery 52 from the engine compartment, the snowmobile 10 further comprises two air dampers AD1 and AD2, two electric damper motors M1 and M2 and an outside temperature sensor TS. Alternatively, any other mechanical thermostat (e.g., bimetal thermostats, wax pellet thermostats, and pneumatic thermostats) which both sense and control temperature can be used as needed and/or desired. The air dampers AD1 and AD2 are either disposed in the ducts D1 and D2 or located at the vent outlets V1 and V2 for regulating the air flow in the ducts D1 and D2. In particular, the electronic controller 56 selectively controls the damper motors M1 and M2 to operate the air dampers AD1 and AD2. Preferably, the air dampers AD1 and AD2 are thermostatically controlled between a first position increasing airflow to the lithium battery 52 and a second position decreasing airflow to the lithium battery 52. More specifically, the electronic controller 56 operates one or both of the damper motors M1 and M2 to selectively increases airflow to the lithium battery 52 and decrease airflow to the lithium battery 52 based on a detected temperature. The detected temperature can be a detected temperature of the lithium battery 52 or an outside air temperature detected by the temperature sensor TS. By closing the air dampers AD1 and AD2, the heated air from the engine compartment would stop flowing towards the lithium battery 52. The temperature sensor TS can also be used to control the electric battery heater (not shown) so that the electric battery heater is turned on in very cold conditions when the engine 32 is not running.

Optionally, as seen in FIG. 8, the lithium power module 50 further comprises a display 80 for displaying various battery related information, one or more user inputs 81, one or more I/O interfaces 82 and the I/O ports 83. Here, as seen in FIGS. 6 and 7, the lithium power module 50 includes two USB ports P1 and P2 as one example of the I/O ports 83 and a push button P4 for setting modes of operation as one example of the user input 81. Of course, it will be apparent from this disclosure that the lithium power module 50 can include other types of the I/O ports and user inputs as needed and/or desired. Also, optional, as seen in FIG. 8, the lithium power module 50 further comprises a GPS Navigation system 84 for providing navigation information, a plurality of prestored applications 85 stored in the memory 64, a transceiver 86 for receiving and transmitting wireless signals such as remote assistance, a kill switch 88 and a flashlight 90. Of course, it will be apparent from this disclosure that the lithium power module 50 does not need to include all of the features. Rather, the lithium power module 50 can include some or none of these features, or can include other features not mentioned herein. For example, the lithium power module 50 can be configured to include a headlight for the snowmobile 10 when the lithium power module 50 is installed on the snowmobile 10. This headlight would also work as a flashlight when the lithium power module 50 is removed from the snowmobile 10.

As seen in FIG. 8, in the illustrated embodiments, the portable lithium power module 50 further one or more user inputs 81, one or more I/O interfaces 82 and one or more I/O ports 83. Charging circuits, user inputs, I/O interfaces and I/O ports are extremely well known in the computer field, therefore no further description will be provided. In this way, a variety of devices can be connected to the portable lithium power module 50 for receiving electrical power and/or for communicating with the electronic controller 60.

In the illustrated embodiments, as seen in FIG. 6, the portable lithium power module 50 has a tether connection port P3 for operating the kill switch 88 and a standard three prong electrical outlet P5. Thus, the lithium power module 50 includes a pluggable power port, namely, the USB ports P1 and P2 and the electrical outlet P5. The portable lithium power module 50 can be recharged by plugging in a charger into one of the USB ports and then plugging the charger into a household electrical outlet, similar to charging a cell phone. Thus, the USB ports are power and signal outlets. Preferably, the portable lithium power module 50 can also be charged from the snowmobile stator via the charging circuit 72.

The USB ports P1 and P2 can be used to plug other devices into the portable lithium power module 50 for either receiving power from the lithium battery 52 or communicating with the electronic controller 60. Examples of other devices include, but not limited to, smart phones, tablets, laptops, heated riding gear, etc.

The tether connection port P3 is configured to connect a tether line 92 to the portable lithium power module 50. Specifically, one end of the tether line 92 has a rider attachment 92a (e.g., a wrist strap) that is attached to the rider, while the other end of the tether line 92 is plugged into the tether connection port P3. When the tether line 92 is plugged into the tether connection port P3, the kill switch 88 is closed and the electronic controller 60 permits the engine 32 of the snowmobile 10 to continue to run. However, when the tether line 92 is unplugged from the tether connection port P3, the kill switch 88 is open and the electronic controller 60 shuts off the engine 32 of the snowmobile 10. In this way, if the rider falls off the snowmobile 10, then the electronic controller 60 will shut off the engine 32.

The electrical outlet P5 is configured to connect higher voltage devices to the lithium battery 52. For examples, higher voltage devices include, but not limited to, chainsaws, power tools, heated jacket, ice auger, sonar flasher system, blue tooth communication devices, etc. Also, when the portable lithium power module 50 is removed from the snowmobile 10, the second electrical connection EC2 of the portable lithium power module 50 can be connected to a jumper cable for jump starting other vehicles.

As seen in FIG. 10, the processor 62 of the electronic controller 60 executes a control process for reserving a predetermined amount of battery level to start the engine 32 of the snowmobile. The control process of the flow chart in FIG. 10 is executed at predetermined intervals after the portable lithium power module 50 is plugged into the battery support 40a and the first and second electrical connections EC1 and EC2 are engaged.

In step S10 of the control process, the processor 62 monitors the battery level (SoC) of the lithium battery 52 by receiving and storing the voltage value and/or the current value in the memory 64. Next, the control process proceeds to step S11.

In step S11 of the control process, the processor 62 determines the battery level (SoC) of the lithium battery 52. The battery level (SoC) of the lithium battery 52 can also be referred to as the remaining capacity of the lithium battery 52. The battery level (SoC) of the lithium battery 52 can be determined in many ways. For example, the remaining capacity of the lithium battery 52 can be estimated using the voltage values from the voltage sensor 66 and the current values from the current sensor 68. Preferably, the estimated battery level (SoC) of the lithium battery 52 is also base on a temperature reading using the temperature sensor TS provided on the snowmobile or the temperature sensor 70 in the portable lithium power module 50. Since estimating a battery level (SoC) of a lithium battery is well known, a detailed discussion of the many different estimation methods will not present herein for the sake of brevity. After estimating the battery level (SoC) of the lithium battery 52, the control process proceeds to step S12.

In step S12 of the control process, the processor 62 compares the battery level (SoC) of the lithium battery 52 with a predetermined battery reserve threshold stored in the memory 64. The predetermined battery reserve threshold can be adjusted by the rider as needed and/or desired from a default or factory threshold setting. If the battery level (SoC) of the lithium battery 52 is above the predetermined battery reserve threshold, then the control process proceeds back to step S10. On the other hand, if the battery level (SoC) of the lithium battery 52 is below the predetermined battery reserve threshold, then the control process proceeds to step S13.

In step S13 of the control process, the processor 62 implements a power saving mode in which selected various applications and/or features that consume electrical power from the lithium battery 52 will be shut down and/or disabled until the lithium battery 52 is recharged above the predetermined battery reserve threshold. After entering the power saving mode, the control process proceeds to step S14.

In step S14 of the control process, the processor 62 notifies the rider of the lithium battery 52 falling below the predetermined battery reserve threshold. The low battery notification can be accomplished in one or more ways. For example, a low battery notification can be displayed on the display 48a. Alternatively, a low battery notification can be sent to the rider's phone, which can ring or vibrate as well as display the low battery notification. After the low battery notification has been sent, the control process ends until the lithium battery 52 is recharged above the predetermined battery reserve threshold.

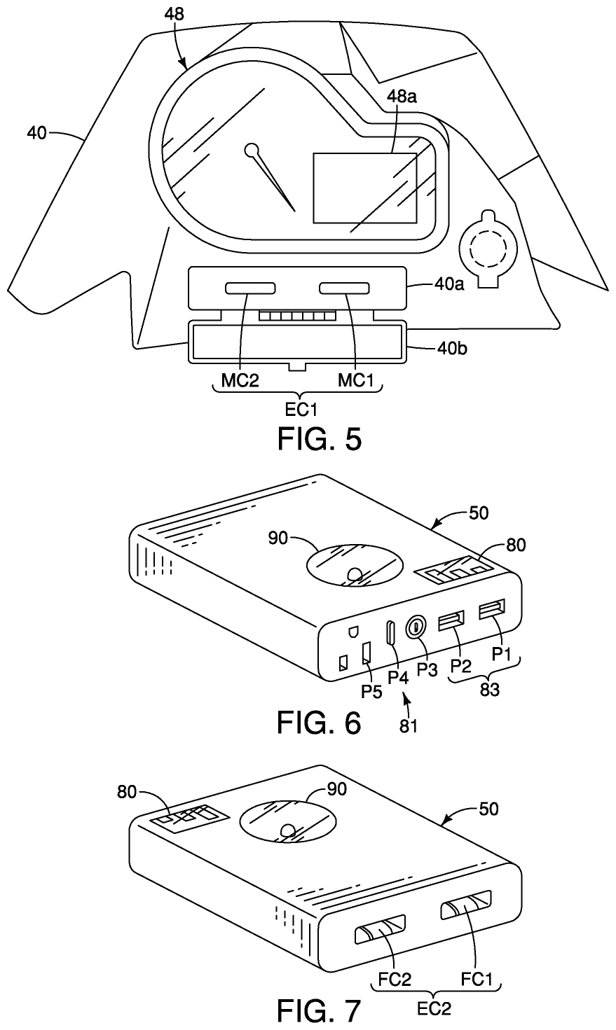

Referring now to FIGS. 11 and 12, an alternative placement of the lithium power module 50 is illustrated. Here, the seat panel 36 is provide a battery support 36b that defines a battery receiving port located inside the storage area 36a. The battery receiving port of the battery support 36b is configured to toollessly connect and disconnect the lithium power module 50 to the electrical system of the snowmobile 10. In this way, the lithium power module 50 can be locked within the storage area 36a while electrically connected to the electrical system of the snowmobile 10. In particular, the battery support 36b also includes an electrical connection, which is electrically connected to the electrical system of the snowmobile 10. A lid 36c is pivotally attached to the battery support 36b to cover the electrical connection inside the recess defined by the battery support 36b. The electrical connection inside the battery support 36b is the same as the first electrical connection EC1 shown in FIG. 5. Thus, the battery support 36b receives the lithium power module 50 in the same way as the battery support 40a. Alternatively, the stationary seat 14b can be provided with a battery support 36b′ that defines a battery receiving port for receiving the lithium power module 50. Here, like the other battery supports, a lid 36c′ is pivotally mounted to the battery support 36b′. Thus, the lithium power module 50 can be disposed in either the saddle seat section 12b of the vehicle body 12 or the saddle seat 14 (e.g., the stationary seat 14b).

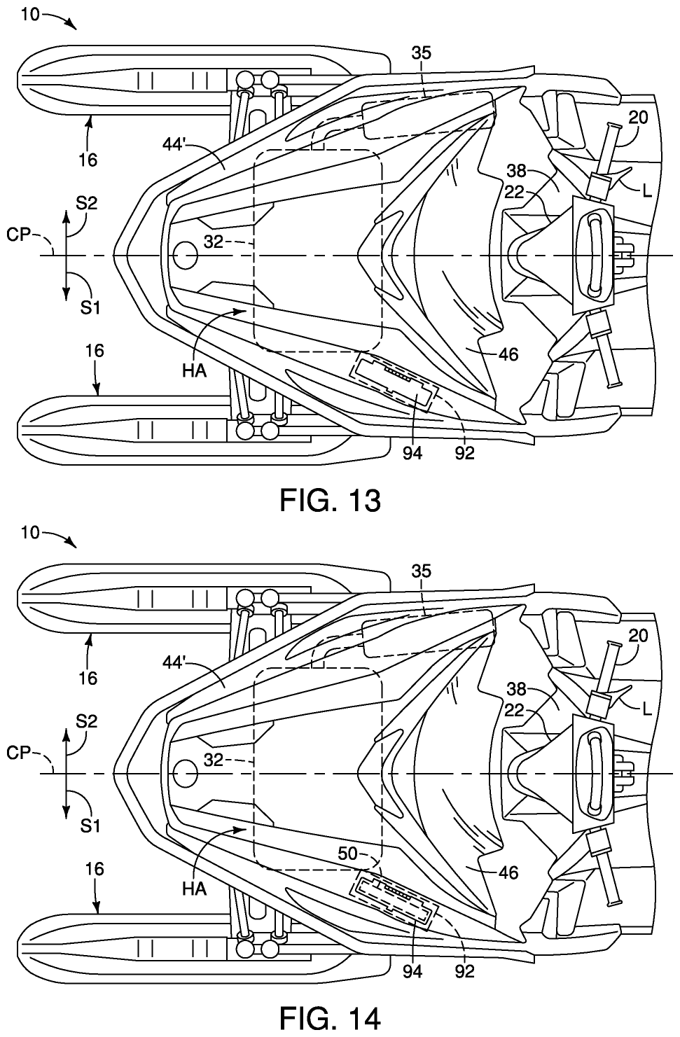

Referring now to FIGS. 13 and 14, an alternative placement of the lithium power module 50 is illustrated. Here, the lithium power module 50 is disposed in a vehicle heat generated area HA of the snowmobile 10. In this way, the lithium power module 50 can be warmed by the heat generated from the engine 32 during the operation of the snowmobile 10. For example, in this embodiment, the vehicle heat generated area HA includes an engine heat generated area. More specifically, in this embodiment, the vehicle heat generated area HA corresponds to the engine compartment defined by the hull 42 and a front engine cover 44′.

The vehicle body 12 has a longitudinal center plane CP dividing the snowmobile 10 into first and second lateral sides S1 and S2. The engine 32 has an exhaust system 35 that is primarily disposed on one of the first and second lateral sides S1 and S2. The exhaust system 35 includes a header, a muffler, a mid-pipe (optionally), and a turbo charger (optionally). Preferably, the lithium power module 50 is disposed on the other of the first and second lateral sides S1 and S2 adjacent to the engine 32. Here, the exhaust system 35 is disposed primarily on the first lateral side S1 of the snowmobile 10, which corresponds to the right side of the snowmobile 10 as viewed from a rider seated in a normal riding position on the saddle seat 14. Thus, the lithium power module 50 is disposed on the second lateral side S2 of the snowmobile 10, which corresponds to the left side of the snowmobile 10 as viewed from a rider seated in a normal riding position on the saddle seat 14. However, the lithium power module 50 can be disposed on the first lateral side S1 of the snowmobile 10 when the exhaust system 35 is disposed on the second lateral side S2 of the snowmobile 10. In other words, based on the snowmobile design, the exhaust system 35 and the lithium power module 50 are disposed on opposite sides of the longitudinal center plane CP of the snowmobile 10. In this way, the lithium power module 50 is kept warm by the heat from the engine 32 while the engine 32 is running. However, the lithium power module 50 is protected from overheating due to the heat from the exhaust system 35.

Here, in this embodiment, the hull 42 is provided with a battery support 92 that defines a battery receiving port located inside the vehicle heat generated area HA. The front engine cover 44′ is provided with a lid 94 that covers the battery receiving port of the battery support 92. The battery receiving port formed by the battery support 92 is configured to toollessly connect and disconnect the lithium power module 50 to the electrical system of the snowmobile 10. In particular, the battery support 92 also includes the first electrical connection EC1 (see FIGS. 5 and 8), which is electrically connected to the electrical system of the snowmobile 10. The lid 94 is pivotally attached to the front engine cover 44′ to cover the electrical connection inside the recess defined by the battery support 92. The first electrical connection EC1 inside the battery support 92 is the same as the first electrical connection EC shown in FIGS. 5 and 8. Thus, the battery support 92 receives the lithium power module 50 in the same way as the battery support 40a. Here, the battery receiving port of the battery support 92 is deeper than the other battery supports such that the lithium power module 50 is completely covered with the lid 94 while the first and second electrical connections are connected.

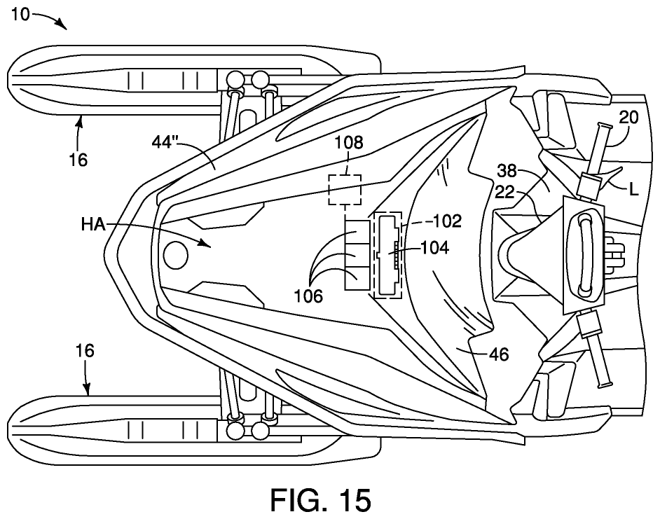

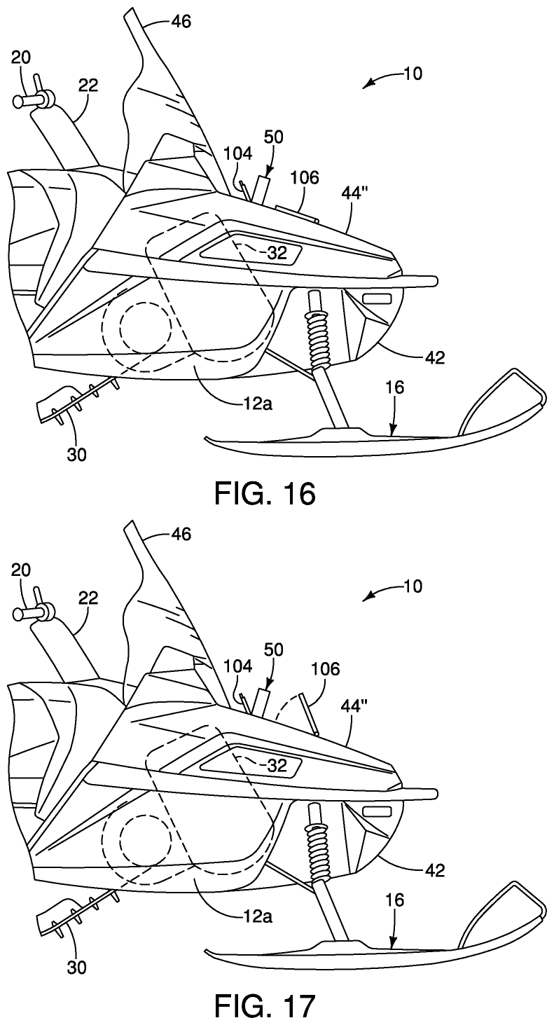

Referring now to FIGS. 15 to 16, an alternative placement of the lithium power module 50 is illustrated. Here, the lithium power module 50 is disposed in the vehicle heat generated area HA of the snowmobile 10 so that the lithium power module 50 can be warmed by the heat generated from the engine 32 during the operation of the snowmobile 10. However, in this position, the lithium battery 52 in the lithium power module 50 may become overheated depending on the weather conditions.

In this embodiment, the front engine cover 44″ is provided with a battery support 102 that defines a battery receiving port located inside the vehicle heat generated area HA. The front engine cover 44″ is provided with a lid 104 that covers the battery receiving port of the battery support 102 when the lithium power module 50 is not installed. Here, when the lithium power module 50 is installed in the battery receiving port of battery support 102, about one-quarter of the lithium power module 50 is located above the front engine cover 44″. The same as the other embodiments, the battery receiving port formed by the battery support 102 is configured to toollessly connect and disconnect the lithium power module 50 to the electrical system of the snowmobile 10.

To regulate the airflow against the lithium power module 50, the front engine cover 44″ is provided with at least one air damper 106. Here, the front engine cover 44 has three air dampers 106 that can be individually controlled by the electronic controller 56 operating electric damper motors. Preferably, the air dampers 106 are automatically controlled based on a detected temperature of either the lithium battery 52 or an outside air temperature detected by the temperature sensor TS. Alternatively, any other mechanical thermostat (e.g., bimetal thermostats, wax pellet thermostats, and pneumatic thermostats) which both sense and control temperature can be used as needed and/or desired. The air dampers 106 are movable through an infinite number of positions. As seen in FIG. 16, the air dampers 106 are in a retracted position to permit air to flow towards the lithium battery. As seen in FIG. 17, the air dampers 106 are in an extended position to block air from flowing towards the lithium battery 52 of the lithium power module 50. Thus, in this situation, the air flow towards the lithium power module 50 is regulated to maintain the temperature of the lithium battery 52 within a predetermined temperature range.

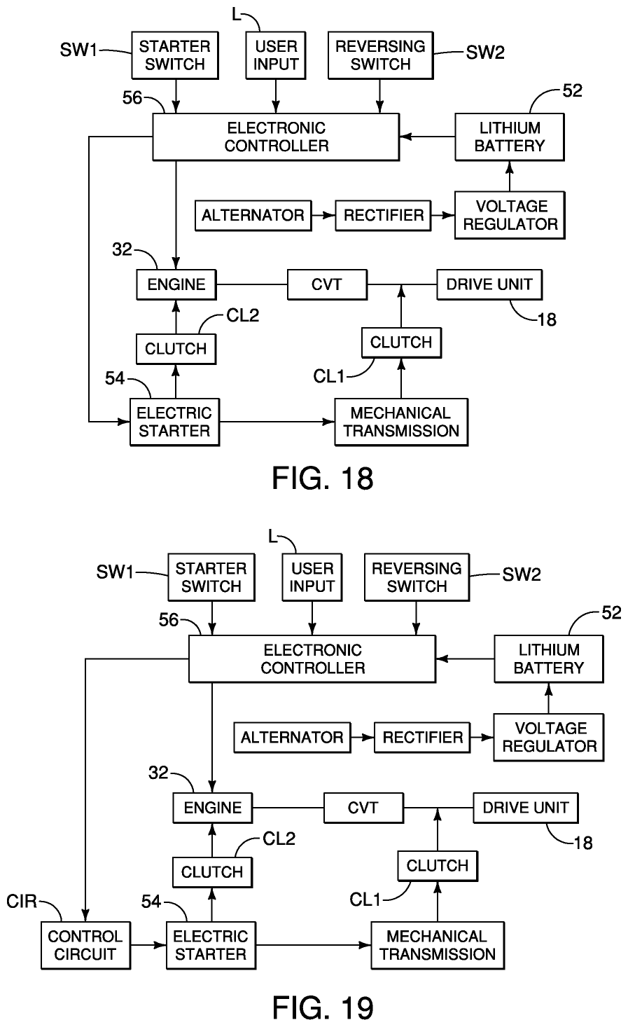

Referring now to FIGS. 18 to 21, two methods of driving the drive unit 18 in reverse using the starter motor 54a will now be discussed. The functional block diagram of the snowmobile 10 illustrate in FIGS. 18 and 19 applies to all of the embodiments disclosed herein. Basically, the snowmobile 10 is provided with a reversing switch SW2. While the reversing switch SW2 is illustrated as being a separate and apart from the starter switch SW1, it will be apparent from this disclosure that the reversing switch SW2 and the starter switch SW1 can be a single integrated one user operated switch. For example, a single knob or lever can be provided in which movement of the knob or lever in a first direction starts the engine 32, while movement of the knob or lever in a second direction (opposite to the first direction) drives the track belt 30 in the reverse direction using the starter motor 54a. While the lithium battery 52 of the lithium power module 50 is used for supplying the electrical power to the starter motor 54a for driving the track belt 30 in the reverse direction, a standard lead acid battery can be used. The lead acid battery can be provided on the snowmobile 10 in a conventional manner. Also, the engine 32 does not necessarily need to be running during the second vehicle condition. However, it may be advantageous for the engine 32 to be running so the battery power to the starter motor 54a can be supplemented with electrical power from the alternator, which is operated by the engine 32 in a conventional manner. The alternator also is used to charge the lithium battery 52 when the engine 32 is running.

In the case of the functional block diagram of the snowmobile 10 illustrate in FIG. 18, the rider operates the starter switch SW1 to start the engine 32 with the snowmobile 10 being in a first vehicle condition (e.g., the engine stopped). With the engine 32 running at idle, the engine 32 does not transmit power through the CVT so that the drive unit 18 is not being driven by the engine 32. Basically, the CVT of the snowmobile 10 acts as a clutch. In this way, the CVT is driven by the engine 32, but the CVT does not transmit significant amounts of power to the drive unit 18 when the engine 32 is at low rpm (idle). Also, with the engine 32 running and the drive unit 18 not being driven by the engine 32, a first clutch CL prevents power from being transmitted between the electric starter 54 and the drive unit 18, and a second clutch CL2 (one-way clutch) prevents the starter motor 54a from being rotated by the operation of the engine 32. In this way, so long as the engine 32 is running, the power of the electric starter 54 will not be transmitted through the engine 32 and the power of the engine 32 will not be transmitted to the electric starter 54. While the second clutch CL2 is shown as a separate unit, typically, the second clutch CL2 is an integrated part of the engine 32.

Now, when a rider wants to drive the snowmobile 10 in reverse with the snowmobile 10 being in a second vehicle condition (e.g., the engine running and CVT not transmitting power from the engine 32), then the rider operates the reversing switch SW2 to operate the electric starter 54 to drive the drive unit 18 in reverse. In other words, the rotation of an output shaft of the starter motor 54a is not transmitted through the engine 32 but is transmitted to the drive unit 18 to drive the drive unit 18 in reverse. A mechanical transmission OT (e.g., one or more of a gear train, a chain drive, a belt drive, etc.) operatively connects the output shaft of the starter motor 54a to the drive unit 18 such that the drive unit 18 is operated to turn the track belt 30 in the reverse direction. In this way, rider can back up the snowmobile 10 using the starter motor 54a to turn the track belt 30 in the reverse direction. By varying the operation of the throttle via the user input L or some other suitable user input, the rider can regulate the power to the track belt 30. If the user input L (i.e., the throttle lever) is used for regulating the power to the track belt 30, then the electronic controller 56 will need to limit the rpm of the engine 32 while in the second vehicle condition (the engine running and CVT not transmitting power from the engine 32). The rider then operates the reversing switch SW2 for a second time to resume a conventional operating mode. In this way, operation of the user input L causes the track belt 30 to move to drive the snowmobile 10 in a forward direction.

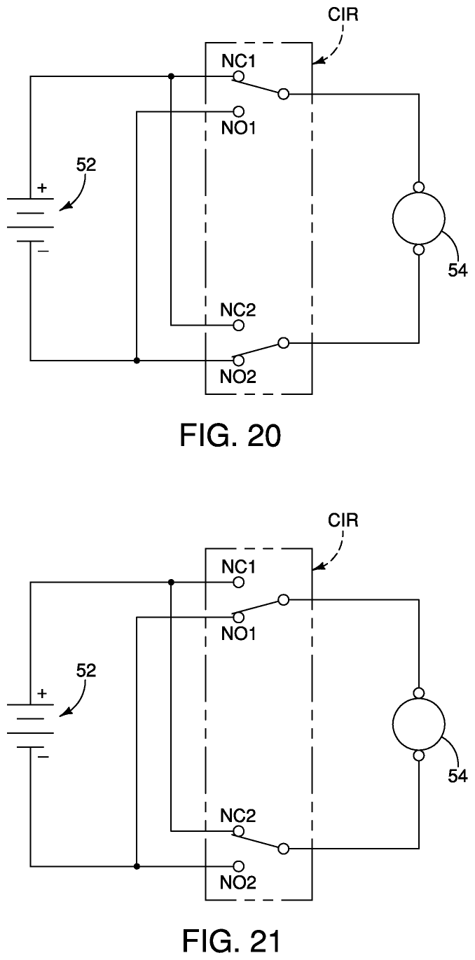

In the case of the functional block diagram of the snowmobile 10 illustrate in FIG. 19, a control circuit CIR (electrical circuit) is provided for changing the polarity of electricity to the electric starter 54. By reversing the polarity of the electricity from the lithium battery 52 to the electric starter 54, the output shaft of the starter motor 54a is changed from rotating in a first rotational direction to start the engine 32 to rotating in a second rotational direction to drive the drive unit 18 in reverse. The control circuit CIR is controlled by the electronic controller 56 in response to operation of the reversing switch SW2. As seen in FIG. 20, the control circuit CIR (the electrical circuit) has a first current flow path from the lithium battery 52 to a first terminal of the electric starter 54 to establish a first polarity of electricity to the electric starter 54 to operate the electric starter 54 in a first direction. As seen in FIG. 21, the control circuit CIR (the electrical circuit) has a second current flow path from the lithium battery 52 to a second terminal of the electric starter 54 to establish a second polarity of electricity to the electric starter 54 that is opposite the first polarity to operate the electric starter 54 in a second direction. The electronic controller 56 connects the lithium battery 52 to the first terminal of the electric starter 54 to start the engine 32 by establishing the first current flow path when the reversing switch SW2 has not been operated, and selectively connects the lithium battery 52 to the second terminal of the electric starter 54 to drive the drive unit 18 in a reverse direction by establishing the second current flow path in response to operation of the reversing switch SW2. Of course, other electromechanical arrangements can be used to drive the snowmobile 10 in reverse in which the first clutch CL1 is preferably a one way clutch, but not limited to a one way clutch.

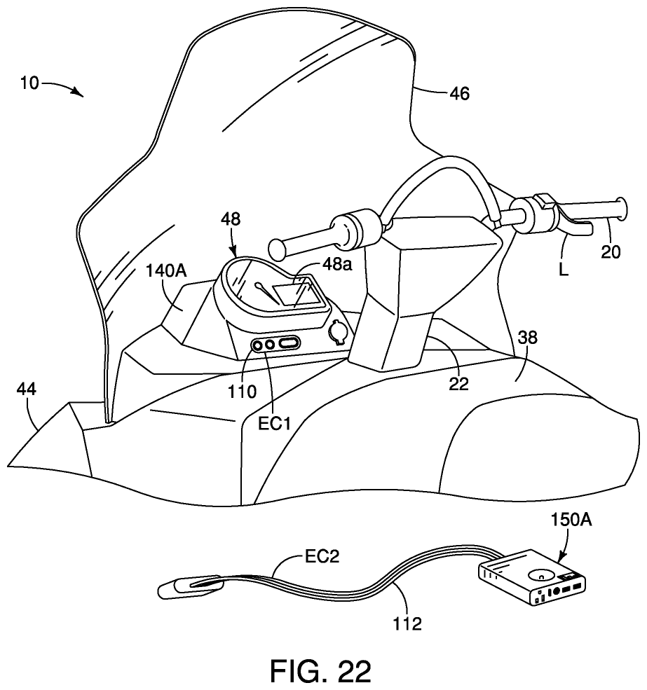

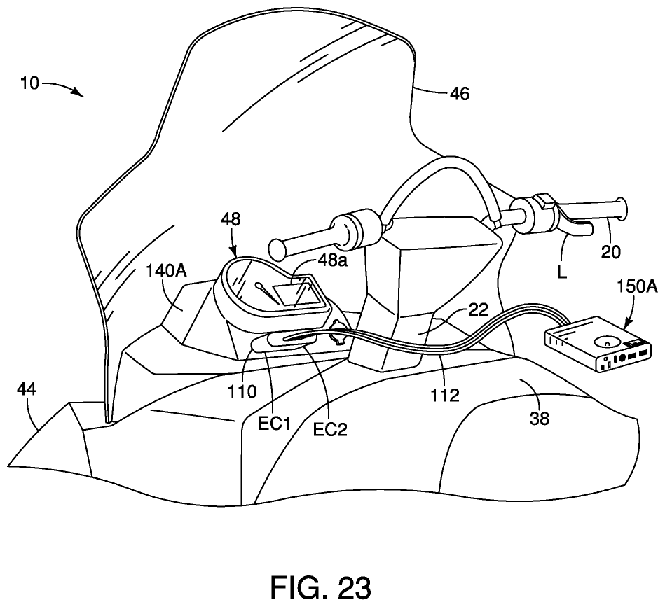

Referring now to FIGS. 22 and 23, the snowmobile 10 has been modified to have a modified dash panel 140A with a pluggable power and signal port 110 that includes the first electrical connection EC1 (e.g., a female electrical receptacle having a pair of power contacts and a data contact). Here, a lithium power module 150A includes an electrical cord 112 that has a second electrical connection (e.g., a male electrical connector having a pair of power contacts and a data contact) formed at its free end. The other end of electrical cord 112 is electrically connected to the lithium battery 52 of the lithium power module 150A. The lithium power module 150A is identical to the lithium power module 50 except that instead of using Power Line Communication to send data, a dedicated data line is provided. The electrical cord 112 is configured to be detachably connected to the pluggable power and signal port 110 without tools just like in the prior embodiments. Here, the rider can keep the lithium power module 150A in a pocket so that the lithium power module 50 remains warm while riding. Also, the electrical cord 112 in conjunction with the power detection circuit 58 can shut off the engine 32 in the event the rider falls off the snowmobile 10. As mentioned above, the power detection circuit 58 is electrically connected to an electrical path between the lithium battery 52 and the starter solenoid 54b. The electronic controller 56 is operatively coupled to the power detection circuit 58 and the engine 32. The electronic controller 56 is programmed to shut off the engine 32 in response to the power detection circuit 58 detecting the lithium battery 52 is no longer connected to the electrical system of the snowmobile 10. The power detection circuit 58 acts as a kill switch in the situation in which the electrical cord 112 is disconnected from the pluggable power and signal port 110.

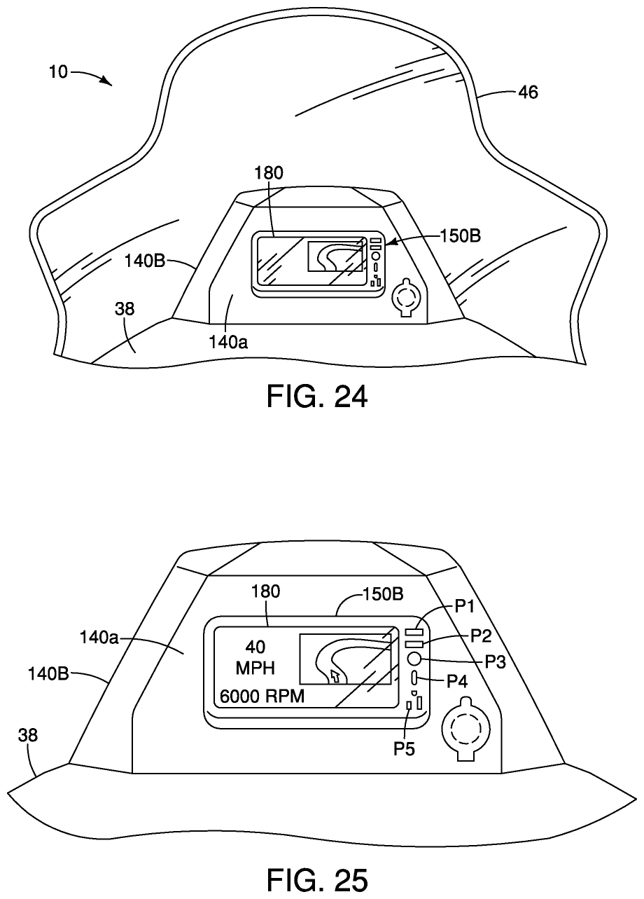

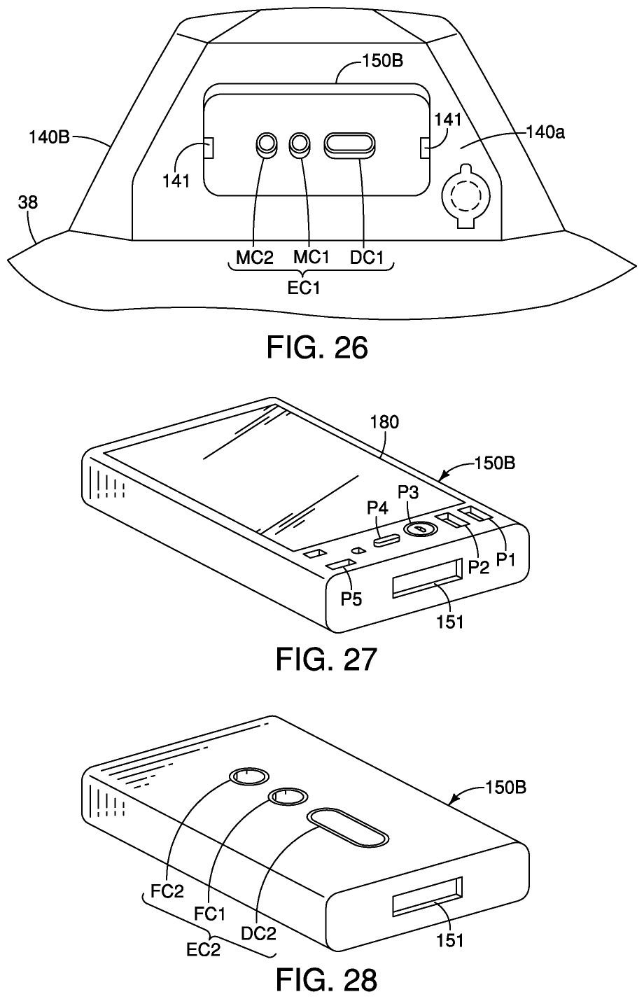

Referring now to FIGS. 24 to 28, the snowmobile 10 has been modified to have a modified dash panel 140B with a display and battery support 140a for receiving a portable lithium power module 1501 that includes a display 180. Here, the portable lithium power module 150B is plugged into the display and battery support 140a of the modified dash panel 140B. Thus, like all of the other embodiments, the portable lithium power module 150B has a lithium battery is that is configured to be toollessly connected and disconnected to the electrical system of the snowmobile 10.

Basically, the portable lithium power module 150B is functionally identical to the portable lithium power module 50 except that (1) a dedicated data line is provided to send data instead of using Power Line Communication, (2) the flashlight 90 being omitted, and (3) the display 180 has been added that functions as the dash panel instrument display for the snowmobile 10. Thus, the various operating conditions (vehicle speed, engine rpm's, etc.) of the snowmobile 10 and navigational information are displayed on the display 180 of the portable lithium power module 150B. Here, the display and battery support 140a includes the first electrical connection EC1 (e.g., a male electrical receptacle having a pair of power contacts MC1 and MC2 and a data contact DC1). Also, here, the lithium power module 150B includes the second electrical connection EC2 (e.g., a female electrical connector having a pair of power contacts FC1 and FC2 and a data contact DC2).

Also, here, the housing of the portable lithium power module 150B has recesses 151 (only one shown) on opposite side edges that are engaged by spring biased detents 141 when the portable lithium power module 150B is disposed in the display and battery receiving port defined by the display and battery support 140a. In this way, the portable lithium power module 150B can be removably retained in the modified dash panel 140B.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Thus, as used herein, the singular forms “a,” “an” and “the” are intended to include the plural forms as well, unless the context clearly indicates otherwise. Also, the terms “part,” “section,” “portion,” “member” or “element” when used in the singular can have the dual meaning of a single part or a plurality of parts. Unless otherwise defined, all terms (including technical and scientific terms) used herein have the same meaning as commonly understood by one of ordinary skill in the art to which illustrative embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

It will be understood that when an element is referred to as being “connected” or “coupled” to another element, it can be directly connected or coupled to the other element or intervening elements may be present. In contrast, when an element is referred to as being “directly connected” or “directly coupled”” to another element, there are no intervening elements present. As used herein the term “and/or” includes any and all combinations of one or more of the associated listed items. Additionally, similar words used to describe the relationship between elements or layers should be interpreted in a like fashion (e.g., “between” versus “directly between”, “above” versus “directly above”, “below” versus “directly below”, “adjacent” versus “directly adjacent,” “on” versus “directly on”). Thus, components that are shown directly connected or contacting each other can have intermediate structures disposed between them unless specified otherwise.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three.

Also, it will be understood that, although the terms “first”, “second”, etc. may be used herein to describe various elements, components, regions, positions and/or sections, these elements, components, regions, positions and/or sections should not be limited by these terms. These terms are only used to distinguish one element, component, region, layer, position or section from another element, component, region, layer, position or section. Thus, a first element, component, region, position or section discussed above could be termed a second element, component, region, position or section without departing from the teachings of illustrative embodiments.

Spatially relative terms, such as “forward”, “rearward”, “above”, “below”, “beneath”, “downward” “vertical”, “horizontal”, and “transverse” as well as any other similar spatial terms may be used herein for the ease of description to describe one element or feature's relationship to another element(s) or feature(s) of the above embodiments. These terms, as utilized to describe the present invention should be interpreted relative to a snowmobile on a flat horizontal surface and with to a direction in which a rider looks straight when seated on a rider's seat in a straight forward driving direction. Thus, front, rear, left and right shown in the description of the preferred embodiments indicate the front, rear, left and right, respectively, when viewed from a vehicle occupant seated on a seat. The terms of degree such as “substantially”, “about” and “approximately” as used herein mean an amount of deviation of the modified term such that the end result is not significantly changed.

While only selected embodiments have been chosen to illustrate the present invention, it will be apparent to those skilled in this field from this disclosure that various changes and modifications can be made herein without departing from the scope of the invention as defined in the appended claims. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A snow vehicle comprising:
a vehicle body;
a saddle seat provided on the vehicle body;
at least one skis steerably arranged with respect to the vehicle body;
an engine attached to the vehicle body;
a starter motor operatively coupled to the engine and electrically coupled to a first electrical connection; and
a lithium power module having a lithium battery with a second electrical connection that is configured to be toollessly connected and disconnected to the first electrical connection.

2. The snow vehicle according to claim 1, wherein
the lithium power module is disposed in a vehicle heat generated area of the snow vehicle.

3. The snow vehicle according to claim 2, wherein
the vehicle heat generated area includes an engine heat generated area.

4. The snow vehicle according to claim 2, wherein
the vehicle heat generated area includes an electric heat generated area.

5. The snow vehicle according to claim 1, wherein
the lithium power module is partially exteriorly disposed and partially interiorly disposed while the first and second electrical connections are connected.

6. The snow vehicle according to claim 1, wherein
the lithium power module is covered with a lid while the first and second electrical connections are connected.

7. The snow vehicle according to claim 1, wherein
one of the first and second electrical connections includes an electrical cord that is configured to be detachably connected to the other of the first and second electrical connections.

8. The snow vehicle according to claim 7, further comprising
a power detection circuit electrically connected to the one of the first and second electrical connections, and
an electronic controller operatively coupled to the power detection circuit and the engine, the electronic controller shutting off the engine in response to the power detection circuit detecting the first and second electrical connections being disconnected.

9. The snow vehicle according to claim 1, wherein
the lithium power module includes a pluggable power port.

10. The snow vehicle according to claim 1, wherein
the vehicle body has a battery support, and the lithium power module is removably supported to the battery support while the first and second connections are electrically connected.

11. The snow vehicle according to claim 1, wherein
the vehicle body has a longitudinal center plane dividing the snow vehicle into first and second lateral sides,
the engine has an exhaust system that is primarily disposed on one of the first and second lateral sides, and
the lithium power module is disposed on the other of the first and second lateral sides adjacent to the engine.

12. The snow vehicle according to claim 1, further comprising
a windshield provided on the vehicle body, and
the lithium power module being disposed in an area defined between the windshield and the saddle seat.

13. The snow vehicle according to claim 1, wherein
the saddle seat is provided on a saddle seat section of the vehicle body, and
the lithium power module being disposed in one of the saddle seat section of the vehicle body and the saddle seat.

14. The snow vehicle according to claim 2, further comprising
at least one air damper configured to regulate airflow with respect to the lithium battery.

15. The snow vehicle according to claim 14, wherein
the air damper is thermostatically controlled to selectively increases airflow to the lithium battery and decrease airflow to the lithium battery based on a detected temperature.

16. A snow vehicle comprising:
a vehicle body having a longitudinal center plane dividing the snow vehicle into first and second lateral sides;
a saddle seat provided on the vehicle body;
at least one skis steerably arranged with respect to the vehicle body;
an engine attached to the vehicle body and having an exhaust system that is primarily disposed on one of the first and second lateral sides; and
a lithium power module having a lithium battery and disposed on the other of the first and second lateral sides adjacent to the engine.

17. The snow vehicle according to claim 16, wherein
the lithium power module is partially exteriorly disposed and partially interiorly disposed while the first and second electrical connections are connected.

18. The snow vehicle according to claim 16, wherein
the lithium power module is covered with a lid while the first and second electrical connections are connected.

19. The snow vehicle according to claim 16, wherein
the lithium power module includes a pluggable power port.

20. The snow vehicle according to claim 16, wherein
the vehicle body has a battery support, and the lithium power module is removably supported to the battery support while the first and second connections are electrically connected.

21. A snow vehicle comprising:
a vehicle body;
a windshield provided on the vehicle body;
a saddle seat provided on the vehicle body;
at least one skis steerably arranged with respect to the vehicle body; and
a lithium power module having a lithium battery and disposed in an area defined between the windshield and the saddle seat.

22. The snow vehicle according to claim 21, wherein
the lithium power module includes a pluggable power port.

23. A snow vehicle comprising:
a vehicle body having a saddle seat section;
a saddle seat provided on the saddle seat section of the vehicle body;
at least one skis steerably arranged with respect to the vehicle body; and
a lithium power module having a lithium battery and disposed in one of the saddle seat section of the vehicle body and the saddle seat.

24. A snow vehicle comprising:
a vehicle body having a saddle seat section;
a saddle seat provided on the saddle seat section of the vehicle body;
at least one skis steerably arranged with respect to the vehicle body;
a drive unit support by the saddle seat section of the vehicle body, the drive unit including a track belt;
an engine attached to the vehicle body and operatively coupled to the drive unit to drive the drive unit in a forward direction;
a starter motor operatively coupled to the engine and operatively coupled to the drive unit;
a battery electrically coupled to the starter motor; and
at least one user operated switch that operates the starter motor to start the engine in a first vehicle condition, and that operates the starter motor to drive the drive unit in a reverse direction in a second vehicle condition.
